(19) United States
(12) Patent Application Publication
(10) Pub. No.: US 2018/0075258 A1
(43) Pub. Date: Mar. 15, 2018

(54) SYSTEMS AND METHODS FOR DYNAMICALLY ASSIGNING DOMAIN IDENTIFIERS FOR ACCESS CONTROL

(71) Applicant: FREESCALE SEMICONDUCTOR, INC., Austin, TX (US)

(72) Inventors: Joseph C. CIRCELLO, Phoenix, AZ (US); Michael E. LUNDAHL, Gilbert, AZ (US)

(21) Appl. No.: 15/264,865

(22) Filed: Sep. 14, 2016

(51) Int. Cl. G06F 21/70

(52) U.S. Cl. CPC G06F 21/70

(57) ABSTRACT

A master domain assignment controller includes a first plurality of registers corresponding to a first processor including a first register corresponding to a first set of process identifiers (PIDs) and a second register corresponding to a second set of PIDs, and comparison circuitry. The comparison circuitry is coupled to receive an input PID from the first processor and is configured to determine if the input PID is one of the first set or the second set of PIDs. When the input PID is one of the first set of PIDs, a first output domain identifier (DID) is generated, and when the input PID is one of the second set of PIDs, a second output DID different from the first output DID is generated.

### BACKGROUND

### Field

This disclosure relates generally to computer processors, and more specifically, to a computer processor with the capability to dynamically assign domain identifiers for access control.

### Related Art

A resource domain controller in a data processing system includes information that groups various resources, such as bus masters, memory devices, and peripherals, into common domains. Each group can be referred to as a resource domain and can include one or more data processors, memory devices, and peripheral devices. The resource domain information, therefore, assigns data processors, memory devices, and peripherals of a data processing system to one or more resource domains.

In the past, domain assignments were static and could not be changed dynamically. It is desirable to not only support dynamic domain assignments to multiple domains, but also to provide a robust access control policy for system bus transactions among multiple processors.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is a block diagram of a processing system in accordance with selected embodiments of the invention.

FIG. 2 illustrates examples of master domain assignment controller registers for processor and non-processor resources that may be used in the processing system of FIG. 1.

FIG. 3 illustrates an example of inputs and outputs for each master domain assignment controller in accordance with selected embodiments of the invention.

FIG. 4 illustrates a block diagram of a method for generating an output domain identifier for a processor resource in accordance with selected embodiments of the invention.

### DETAILED DESCRIPTION

In embodiments disclosed herein, an Extended Resource Domain Controller (XRDC) is provided with dynamic domain assignments and an integrated, scalable architectural framework for access control, system memory protection, and peripheral isolation. Software assigns chip resources including processor cores, non-core bus masters, memory regions, and slave peripherals to processing domains to support enforcement of robust operational environments. Each bus mastering resource is assigned to a domain identifier (domainID, DID). For processors, there are additional fields that can optionally be used to dynamically assign the processor to multiple domains. Next, the access control policies for the individual domains are programmed into any number of slave memory region descriptors and slave peripheral domain access control registers. All accesses throughout the device are then monitored concurrently to determine the validity of each and every access. If a reference from a given domain has sufficient access rights, it is allowed to continue, otherwise the access is aborted and error information is captured.

In selected embodiments, an access control scheme used in the XRDC supports four levels, combining the traditional privileged and user modes with an additional signal defining the secure attributes of each memory reference. The result is a four level hierarchical access control mechanism, where the attributes have different access control policies based on read, write and execute references. Combined with the privileged/nonprivileged and secure/nonsecure attributes, a domain identifier is associated with every system bus transaction and provides a basis for implementing access control mechanisms.

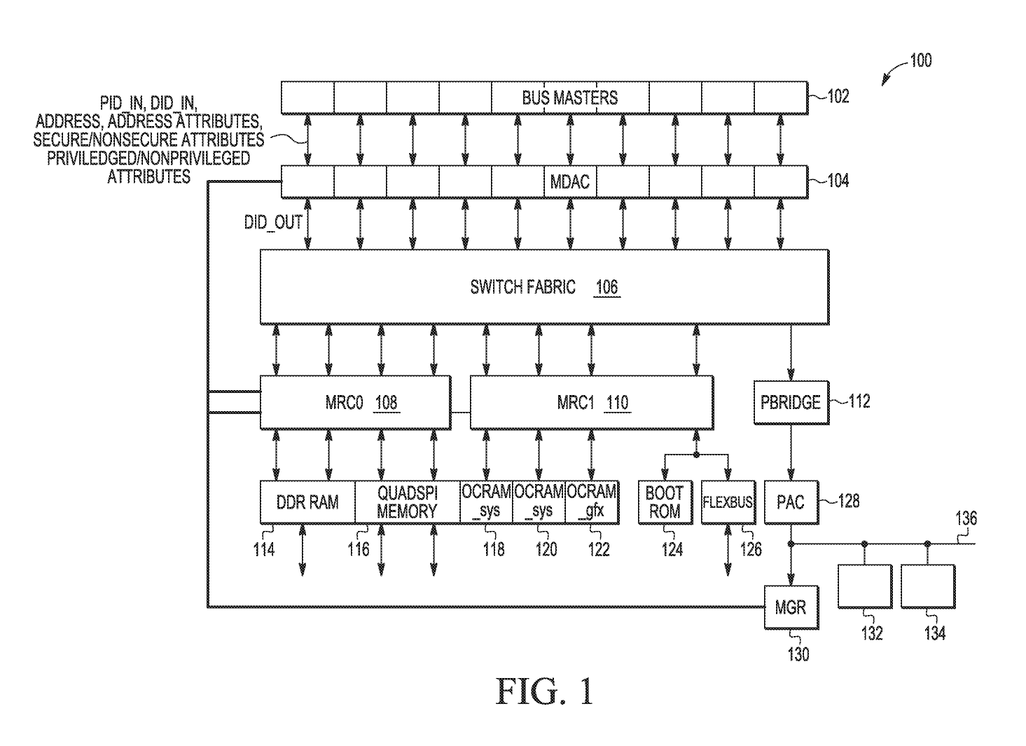

FIG. 1 is a block diagram of a processing system 100 in accordance with selected embodiments of the invention that includes a multitude of bus masters 102, with each bus master 102 configured to communicate with a corresponding instance of master domain assignment controller (MDAC) 104 via a suitable communication link. Parameters communicated between bus masters 102 and MDAC 104 include process identifiers, domain identifiers, memory addresses, memory address attributes, and access attributes such as secure/nonsecure and privileged/nonprivileged attributes, among others. MDACs 104 are configured to communicate with memory region checkers (MRCs) 108, 110 via a switch fabric 106 that routes requests and responses between bus master 102 and MDAC 104 and MRCs 108, 110.

Various memory devices can be coupled to communicate with MRCs 108, 110 including one or more random access memory (RAM) devices, such as double data rate (DDR) RAM module 114, quad serial peripheral interface (QUADSPI) memory 116, system on-chip RAM modules 118, 120, graphics on-chip RAM module 122, boot read only memory (ROM) module 124, and flexible bus module 126. Boot ROM 124 stores code that is executed when a processor is powered up. Flexible bus module 126 allows external devices to be connected to system 100, such as external memory devices, programmable logic devices, or other suitable devices. A communication bus, such as an Advanced Microcontroller Bus Architecture (AMBA) bus, Advanced High-performance Bus (AHB) bus, and/or Advanced Extensible Interface (AXI) bus, can be included to allow memory modules 114-122, boot ROM 124 and flexible bus 126 to communicate with MRCs 108, 110. Other suitable types and number of memory and bus devices can be included in system 100 in addition to, or instead of, the examples of memory devices shown in FIG. 1.

Peripheral bridge (PBRIDGE) 112 can be included to allow additional one or more components to communicate with peripherals 132, 134 in system 100. Peripheral access controller (PAC) 128 is coupled between peripheral bridge 112 and manager module 130. PAC 128 controls access to peripherals 132, 134 by bridge 112 via a communication bus 136, which may be, for example, an advanced peripheral bus or other suitable communication bus. PAC 128 receives requests to access peripherals 132, 134 via bridge 112, and sends responses from peripherals 132, 134 to bridge 112.

Manager module (MGR) 130 routes all accesses of the XRDC programming model to the appropriate destination submodule to configure and control the MDACs 104, MRCs 108, 110 as well as PAC 128. A number of other slave peripherals 132, 134, such as printers, display monitors, phones, thumb drives, and other types of peripheral devices can be accessed. Data flow for accesses to memory regions is controlled by bus master 102 to MDAC 104 to switch fabric 106 to MRC 108, 110 to the appropriate memory controller (114-126). Conversely, the data flow for accesses to slave peripherals is controlled by bus master 102 to MDAC 104 to switch fabric 106 to peripheral bridge 112 to PAC 128 to slave peripheral 130, 132, 134.

Each instance of MDAC 104 generates a domain identifier for every transaction of bus masters 102 and can include multiple master domain assignment (MDA) registers associated with different process identifiers. If there is a single MDA register in a MDAC 104 for a given bus master 102, then the specified domain identifier is used directly. If there are multiple MDA registers for a given bus master 102, then a MDAC 104 evaluates the process identifiers in the registers to determine whether an incoming process identifier matches a process identifier in one of the registers in the corresponding instance of MDAC 104. This referred to as a process identifier “hit”. For all the “hits”, the corresponding domain identifiers in the registers are logically summed together using a Boolean OR operation, for example, to generate the domain identifier. Use cases are typically expected to hit a single MDA register for a bus master 102 at any instant in time. Domain identifiers are dynamically generated based on the contents of the MDA registers and one or more other system register states.

To generate dynamic domain identifiers, one or more MDA registers for a bus master 102 are pre-programmed during system initialization and startup, to specify hit conditions, as further described below. A bus master runtime register state is used by comparison logic in MDAC 104. MDAC 104 compares a specific signal to register fields and associated hit logic to generate a domain identifier. The domain identifier is then treated as an address attribute, passed through switch fabric 106 and used by downstream access control mechanisms in MRCs 108, 110 and PAC 128 to grant or deny access to memory and peripheral devices in system 100.

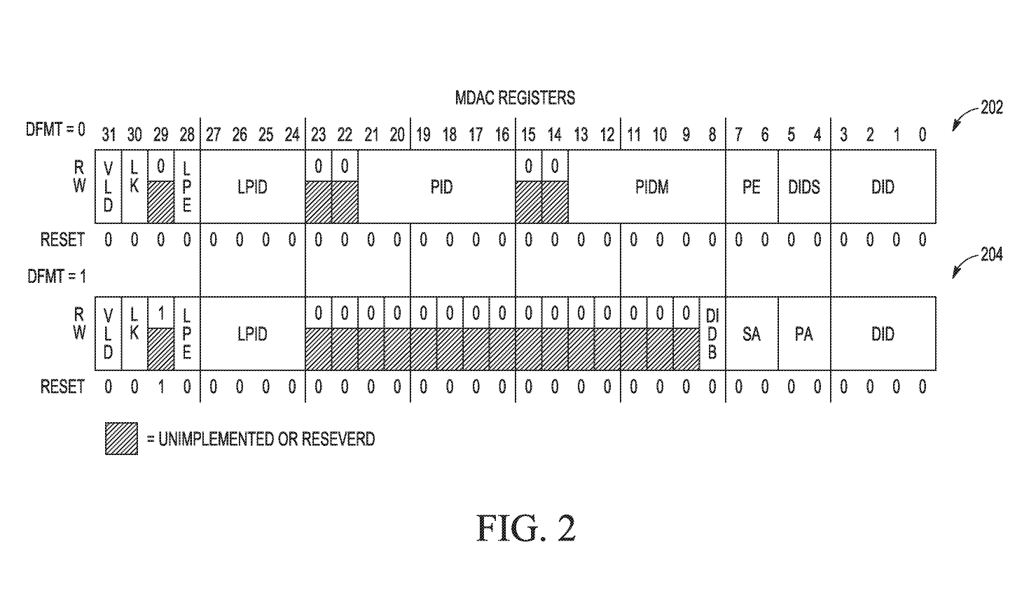

Referring to FIGS. 1 and 2, FIG. 2 illustrates an example of MDA register 202 for processor bus masters 102, and an example of MDA register 204 for non-processor bus masters 102 that may be used in the processing system 100 of FIG. 1. MDA registers 202, 204 provide a two-dimensional data structure for assigning bus masters 102 to domains. In one implementation, for example, there are up to eight 32 bit word-sized registers available for each bus master 102, although a different number may be used. The per-master domain assignment is repeated for each bus master 102. MDACs 104 generate domain identifiers for every transaction from every bus master 102. If there is a single register for a given bus master 102, then the specified domain identifier is used directly. A single register is expected to be used for a non-processor bus master, for example. If there are multiple registers for a given bus master 102, MDACs 104 evaluate terms in the MDA registers to determine a “hit”, i.e., whether a process identifier of an incoming transaction matches a process identifier in a register field within the MDA register 202 that is currently part of system 100. For all register hits, the corresponding domain identifiers are logically summed together, using a Boolean OR function, for example. If none of the terms “hit” in a given register evaluation, the generated domain identifier is null or zero.

In selected embodiments, MDA register 202 for processor resources includes 32 bits that are allocated to the fields shown in the following Table 1:

TABLE 1
MDA register 202 For Processor Resources

| Field | Description |
|---|---|
| 31 | Valid bit. Indicates whether domain assignment is valid (VLD = 1) or invalid |
| VLD | (VLD = 0). |
| 30 | Lock bit. This field indicates whether the MDA register can be written (LK = 0) |
| LK | or is read-only (LK = 1) until the next reset event. |
| 29 | Domain format. This field identifies the register as a processor core domain |
| DFMT | assignment (DFMT = 0) or a non-processor domain assignment (DFMT = 1). |
| | For MDA register 202, DFMT = 0. |
| 28 | Logical partition enable. If system 100 uses virtualization-aware storage, this |
| LPE | field enables the inclusion of a logical partition identifier to be included in the |
| | domain hit evaluation. Note: subsequent discussions on the Boolean |
| | evaluations involving PID and PIDM to determine domain hit assume that LPE = 0. |
| | 0—The LPID field is not included in the domain hit evaluation. |
| | 1—The LPID field is included in the domain hit evaluation. |
| 27-24 | Logical partition Identifier. If system uses virtualization-aware storage, this 4-bit |
| LPID | field defines an optional logical partition identifier (as known as an operating |
| | system number) to be included in the domain hit evaluation. |
| 21-16 | Process Identifier (DFMT = 0 only). This field defines the process identifier to |
| PID | be combined with the PIDM field and included in the domain hit determination |
| | as a function. The optional inclusion of the PID and PIDM is controlled by the |
| | PE field. |
| 13-8 | Process Identifier Mask (DFMT = 0 only). This field provides a masking |
| PIDM | capability so that multiple process identifiers can be included as part of the |
| | domain hit determination. If a bit in the PIDM is set, then the corresponding bit |
| | of the PID is ignored in the comparison. The optional inclusion of the PID and |
| | PIDM is controlled by the PE field. |
| 7-6 | Process identifier enable (DFMT = 0 only). This 2-bit field controls the optional |
| PE | inclusion of the PID, qualified by PIDM, into the domain hit evaluation. It |
| | provides the ability to include inclusive or exclusive sets of masked PID values. |
| | The expressions below assume LPE = 0. |
| | 00—No process identifier is included in the domain hit evaluation |
| | 10—The process identifier is included in the domain hit evaluation as defined |
| | by the expression: |
| | partial_domain_hit = (PE[7:6] == 10) && ((PID[21:16] & ~PIDM[13:8]) == |
| | (PID & ~PIDM[13:8])) |
| | 11—The process identifier is included in the domain hit evaluation as defined |
| | by the expression: |
| | partial_domain_hit = (PE[7:6] == 11) && ~((PID[21:16] & ~PIDM[13:8]) == |
| | (PID & ~PIDM[13:8])) |
| 5-4 | DID Select (DFMT = 0 only). This 2-bit field selects the source of the domain |
| DIDS | identifier. |
| | 00—Use MDAn[3:0] as the domain identifier. |
| | 01—Use the input DID as the domain identifier. |
| | 10—Use bits MDAn[3:2] concatenated with the low-order 2 bits of the input DID |
| | (DID_in[1:0]) as the domain identifier. |
| | 11—Reserved for future use. |
| 3-0 | Domain Identifier. |
| DID | |

In selected embodiments, MDA register 204 for non-processor resources includes 32 bits that are allocated to the fields shown in the following Table 2:

TABLE 2
MDA register 204 For Non-Processor Resources

| Field | Description |
|---|---|
| 31 | Indicates whether domain assignment is valid (VLD = 1) or invalid (VLD = 0). |
| VLD | |
| 30 | Lock bit. This field indicates whether the MDA register can be written (LK = 0) |
| LK | or is read-only (LK = 1) until the next reset event. |
| 29 | Domain format. This field identifies the register as a processor core domain |
| DFMT | assignment (DFMT = 0) or a non-processor domain assignment (DFMT = 1). |
| | For MDA register 204, DFMT = 1. |
| 28 | Logical partition enable. If system 100 uses virtualization-aware storage, this |
| LPE | field enables the inclusion of a logical partition identifier to be included in the |
| | domain hit evaluation. |
| | 0—The LPID field is not included in the domain hit evaluation. |
| | 1—The LPID field is included in the domain hit evaluation |
| 27-24 | Logical partition Identifier. If system uses virtualization-aware storage, this 4-bit |
| LPID | field defines an optional logical partition identifier (as known as an operating |
| | system number) to be included in the domain hit evaluation. |
| 8 | DID Bypass (DFMT = 1 only). If asserted, this bit enables the bypassing of an |
| DIDB | input domain identifier value as the domain identifier for a non-processor bus |
| | master. This capability allows non-processor bus masters, for example, a direct |
| | memory access bus master, to masquerade as a processor. Once set, this |
| | field is “sticky” and remains set until the next reset. |
| | 0—Use MDA register bits [3:0] as the domain identifier. |
| | 1—Use the input DID as the domain identifier. |
| 7-6 | Secure attribute (DFMT = 1 only). This 2-bit field defines the secure/nonsecure |
| SA | attribute for non-processor cores. |
| | 00—Force the bus attribute for this master to secure. |
| | 01—Force the bus attribute for this master to nonsecure. |
| | 1x—Use the bus master's secure/nonsecure attribute directly. |
| | The bus master's input secure/nonsecure attribute is used if SA = 1−, or VLD = 0. |
| 5-4 | Privileged attribute (DFMT = 1 only). This 2-bit field defines the privileged/user |
| PA | attribute for non-processor cores. |
| | 00 Force the bus attribute for this master to user. |
| | 01 Force the bus attribute for this master to privileged. |
| | 1x—Use the bus master's privileged/user attribute directly. |
| | The bus master's input privileged/user attribute is used if PA = 1−, or this VLD = 0. |
| 3-0 | Domain Identifier. |
| DID | |

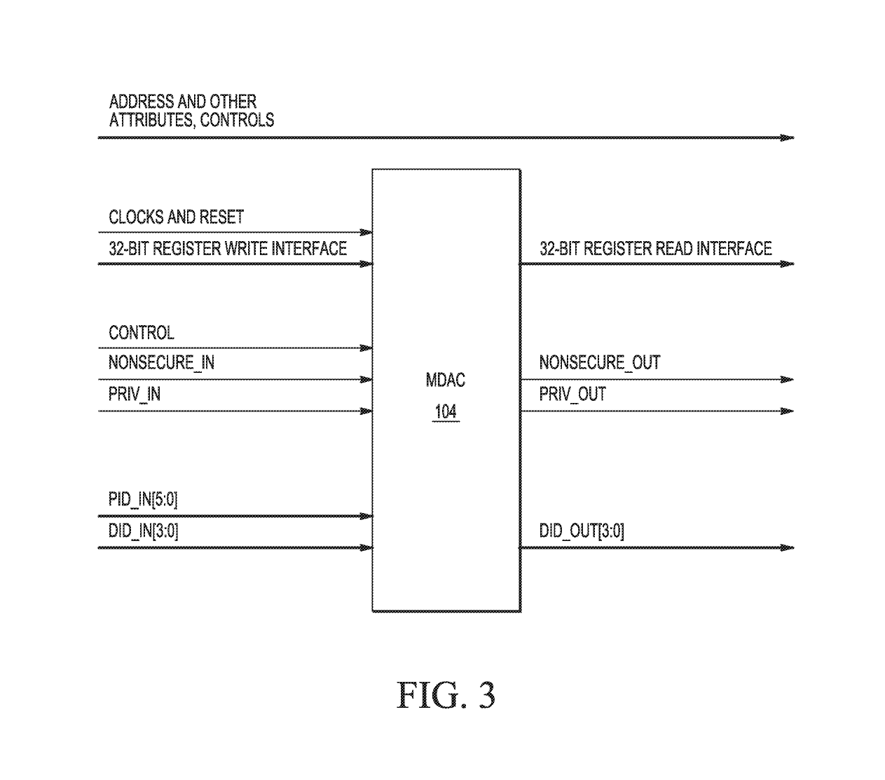

Referring to FIGS. 1-3, FIG. 3 illustrates an example of inputs and outputs for each MDAC 104 in accordance with selected embodiments of the invention. MDAC 104 includes one or more MDA registers for every bus master 102 in system 100. Each instance of MDAC 104 supports a number of parameters that are device-specific, including parameters defining the instance number, the number of implemented domains, the number of MDA registers per corresponding bus master 102, whether the corresponding bus master 102 is a processor, whether a PID value is input, and whether memory virtualization support is included. This configuration information is defined via hardware design parameters and/or specific control input signals. Also note the reference address and other attribute signals pass directly from bus master 102 to switch fabric 106 without passing through MDAC 104.

Further device-specific configuration customization is possible via the input signal connections, as required.

In the example shown, inputs include clock and reset signals, 32 bits of data to be written to a register in MDAC 104, control information, a secure/nonsecure indicator (nonsecure_in), a privileged/nonprivileged indicator (priv_in), an input process identifier (pid_in[5:0]), and an input domain identifier (did_in[3:0]). Output includes 32 bits of data read from a register in MDAC 104, an output secure/nonsecure indicator (nonsecure_out), an output privileged/nonprivileged indicator (priv_out), and an output domain identifier (did_out[3:0]).

The following C code, evaluate_MDA, is an example of a software description to generate a domain identifier and determine whether there is a “hit” in each of MDA registers for processor resources, that is, whether a process identifier of an incoming transaction matches the process identifier on one or more of the MDA registers for a processor bus master 102:

evaluate_MDA (instance_number, nonsecure_in, priv_in, master_in, pid_in, did_in)

| | | |
|---|---|---|
| unsigned int | instance_number; | // master instance number |
| unsigned int | nonsecure_in; | // nonsecure input attribute |
| unsigned int | priv_in; | // privileged input attribute |
| unsigned int | master_in; | // master number input attribute |
| unsigned int | pid_in; | // process identifier input attribute |
| unsigned int | did_in; | // domain identifier input attribute |

```
{
  // evaluate domain assignments and generate domain identifier (DID)
  // this evaluation and generation of the DID requires multiple steps
  // if MDAn == non-core master {
  // select specified DID = f(DIDB) = (DIDB) ? did_in : xrdc_mda_w0[did]
  // generate the {nonsecure, privileged} attributes = f(xrdc_mda_w0[sa,pa]
  // } else {
  // MDAn == processor core
```

| | |
|---|---|
| // select local_pid | = ((xrdc_hwcfg{2,3} & (1 << n)) != 0) |
| // | ? pid_in : xrdc_pid[n] |

```
  // extract pid_register from xrdc_mda_wm_n[21:16 == pid]
  // extract pidm_register from xrdc_mda_wm_n[13: 8 == pidm]
```

| | |
|---|---|
| // select local_did | = f(xrdc_mda_wm_n[5:4 == dids]) |
| // generate did_out | = f(xrdc_mda_wm_n[7:6 == pe]) |
| // select local_nonsecure | = f(tsm, xrdc_hwcfg{2,3} & (1 <<n)) |
| // | = nonsecure_in, (xrdc_pid[n] & 0x20) >> 5, |
| // | pid_in & 0x20) >> 5 |

```
  // generate nonsecure_out
  // generate privileged_out
  // }
  // optionally include the pid & pidm combination in the did evaluation
    // extract the pid and pidm fields from the xrdc_mda register
    pid_register = (xrdc_mda[i][j] & 0x3f0000) >> 16;
    pidm_register = (xrdc_mda[i][j] & 0x3f00) >> 8;
```

| | |
|---|---|
| switch ((xrdc_mda[i][j] & 0xc0) >> 6) { | // isolate pe field |
| case 0: | // pe = 00 |
| case 1: | // pe = 01 |
| did_out[i] \|= local_did; | // source local_did |

break;

| | |
|---|---|
| case 2: | // pe = 10; pid/pidm |

if ((pid_register & ~pidm_register) ==

| \ (local_pid & ~pidm_register)) { | |
|---|---|
| did_out[i] \|= local_did; | // source local_did |

}

| break; | |
|---|---|
| case 3: | // pe = 11; ~pid/pidm |

if ((pid_register & ~pidm_register) !=

\ (local_pid & ~pidm_register)) {

| | |
|---|---|
| did_out[i] \|= local_did; | // source local_did |

```
          }
          break;
    }
  }
```

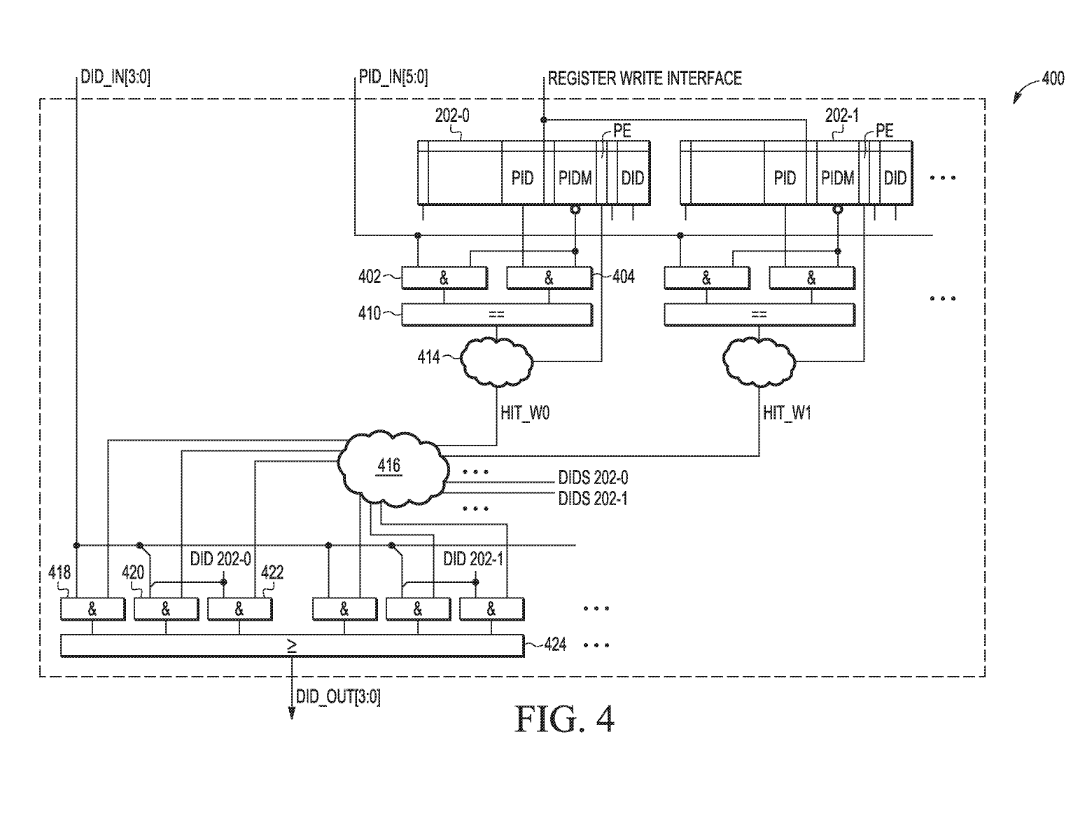

FIG. 4 illustrates a block diagram of a method 400 for generating an output domain identifier for a processor resource in accordance with selected embodiments of the invention. For each MDA register 202-0, 202-1 . . . up to the number of registers for a given domain identifier in MDAC 104, the input process identifier (PID_IN[5:0]) for the transaction is combined with the complement of the process identifier mask (PIDM[13:8]) in the register 202-0, 202-1 in AND circuit 402. Additionally, the process identifier (PID[21:16]) from each register 202-0, 202-1 is combined with the complement of the process identifier mask (PIDM[13:8]) in the register 202-0, 202-1 in AND circuit 404. The output of AND circuits 402, 404 are compared to one another in an equality compare circuit 410 to provide an indicator of whether there is a match between the input PID and the register PID combined with the PIDM in register 202-0, 202-1. The output of compare circuit 410 and the process identifier enable field (PE[7:6]) from each MDA register 202-0 are provided to a corresponding process hit evaluation circuit 414. In process hit evaluation circuit 414, the process identifier enable (PE) field from registers 202-0 and 202-1 controls the optional inclusion of the PID, qualified by a respective process identifier mask (PIDM), into a process hit evaluation circuit 414.

As indicated in the example in Table 1 hereinabove, if the process identifier enable field is set to a first value, e.g. “00”, no process identifier is included in the process hit evaluation. If the process identifier enable field is set to a second value, e.g. “10”, the process identifier is included in the process hit evaluation as defined by the expression partial_domain_hit=(PE[7:6]==10) && ((PID[21:16] & ˜PIDM[13:8])==(PID & ˜PIDM[13:8])). If the process identifier enable field is set to a third value, e.g., “11”, the process identifier is included in the process hit evaluation as defined by the expression: partial_domain_hit=(PE[7:6]==11) && ˜((PID[21:16] & ˜PIDM[13:8])==(PID & ˜PIDM[13:8])).

The output of process hit evaluation circuit 414 for each register 202-0, 202-1 is provided to domain evaluation circuit 416 along with the domain identifier select (DIDS) field in bits [5:4] of the corresponding MDA registers 202-0, 202-1. Domain hit evaluation circuit 416 includes circuitry to select the source of the domain identifier based on the DIDS[5:4] field. As an example for register 202-0, if the domain identifier select field of register 202-0 is set to a first value, e.g., “00”, the domain identifier in bits [3:0] of register 202-0 is used for the domain identifier. Combiner circuit 422 combines the domain identifier in DID [3:0] of register 202-0 with output of domain evaluation circuit 416. If the domain identifier select field of register 202-0 is set to a second value, e.g., “01”, the input domain identifier (DID_IN[3:0]) is used for the domain identifier. Combiner circuit 418 combines the input domain identifier (DID_IN[3:0]) with output of domain evaluation circuit 416. If the domain identifier select field is set to a third value, e.g., “10”, DID [3:2] of register 202-0 concatenated with the low-order 2 bits of the input domain identifier is used for the domain identifier. Combiner circuit 420 combines the concatenated domain identifier with corresponding output of domain evaluation circuit 416. Combiner circuit 424 provides the logical summation across all the implemented MDAn registers to generate a summation of all the “hit” conditions.

As an example of the operation of system 100 with two domains, let a first domain identifier (e.g., “DID=1”) correspond to critical tasks and a second domain identifier (e.g., “DID=2”) correspond to non-critical tasks. An example of a critical task can be a task that monitors an electric meter in a hospital, while non-critical tasks would be all other tasks performed by system 100. Other critical tasks, and other criteria for grouping tasks, can be used, however. Since there are two domains, there would typically be two corresponding registers in MDAC 104. Further, let the processor's task identifier define the critical task with a PID equal to a value between 0 and 15, and the PID for non-critical tasks is assigned a value that is not between 0 and 15. Software initializes registers 202-0, 202-1 in MDAC 104 during startup as follows:

Register 202-0=0x8000_0F81, //VLD, PID=0x0, PIDM=0xF, PE=2, DIDS=0, DID=1

Register 202-1=0x8000_0FC2, //VLD, PID=0x0, PIDM=0xF, PE=3, DIDS=0, DID=2

As a processor coupled to system 100 executes, an appropriate task identifier is loaded into a corresponding PID register of processor 102 as the task is started. The processor's PID register value is input to MDAC 104 and used by multiple logic functions within system 100 (FIG. 1), as shown and described for FIG. 4. For tasks with PID greater than or equal to 0 and less than or equal to 15, register 202-0 “hits” and the domain identifier is “1”. For tasks with a PID greater than 15, then register 202-1 “hits” and the output domain identifier is “2”.

System 100 then supports the dynamic generation of multiple (in this case, two) domain identifiers and the downstream access check logic can distinguish and enforce different access control rights based on the different domain identifiers.

By now it should be appreciated that there has been provided in selected embodiments, a master domain assignment controller (MDAC) (104) can comprise a first plurality of registers (202) corresponding to a first processor 102. The first plurality of registers can comprise a first register corresponding to a first set of process identifiers (PIDs) and a second register corresponding to a second set of PIDs. Comparison circuitry can be coupled to receive an input process identifier (PID) from the first processor and configured to determine if the input PID is one of the first set or the second set of PIDs. When the input PID is one of the first set of PIDs, a first output domain identifier (DID) is generated, and when the input PID is one of the second set of PIDs, a second output DID different from the first output DID is generated.

In another aspect, the first register can be configured to store a first group identifier (e.g., PID, PIDM, and PE) which identifies the first set of PIDs and the second register is configured to store a second group identifier (e.g., PID, PIDM, and PE) which identifies the second set of PIDs, wherein the comparison circuitry is configured to use the first group identifier to determine if the input PID is one of the first set of PIDs and the second group identifier to determine if the input PID is one of the second set of PIDs.

In another aspect, the first group identifier can include a first PID and a first PID mask, and the second group identifier can include a second PID and a second PID mask. The comparison circuitry can be configured to use the first PID masked by the first PID mask to determine if the input PID is one of the first set of PIDs and the second PID masked by the second PID mask to determine if the input PID is one of the second set of PIDs.

In another aspect, the first group identifier can include a first PID enable indicator. The comparison circuitry can be configured to: when the first PID enable indicator has a first value, the input PID is one of the first set of PIDs, if the first PID masked by the first PID mask matches the input PID masked by the first PID mask, and when the first PID enable indicator has a second value, the input PID is one of the first set of PIDs if the first PID masked by the first PID mask does not match the input PID masked by the first PID mask.

In another aspect, the second group identifier can be configured to store a second PID enable indicator, wherein the comparison circuitry can be configured to: when the second PID enable indicator has the first value (e.g. 10), the input PID is one of the second set of PIDs if the second PID masked by the second PID mask matches the input PID masked by the second PID mask, and when the second PID enable indicator has the second value (e.g., 11), the input PID is one of the second set of PIDs if the second PID masked by the second PID mask does not match the input PID masked by the second PID mask.

In another aspect, the first register can be configured to store a first DID and the second register is configured to store a second DID, wherein: when the input PID is one of the first set of PIDs, the first output DID is generated using the first DID (e.g., DID select=01 or 10), and when the input PID is one of the second set of PIDs, the second output DID is generated using the second DID (e.g., DID select=01 or 10).

In another aspect, the first register is configured to store a first DID and a first DID select and the second register is configured to store a second DID and a second DID select, wherein: when the input PID is one of the first set of PIDs, the first output DID is generated using the first DID select and at least one of the first DID and an input DID received from the processor (e.g., DID select=00, 01, or 10), and when the input PID is one of the second set of PIDs, the second output DID is generated using the second DID select and at least one of the second DID and the input DID.

In another aspect, when the input PID is one of the first set of PIDs and the first DID select has a first value (e.g., 00), the first DID is provided as the first output domain identifier (DID), and when the input PID is one of the first set of PIDs and the first DID select has a second value (e.g., 01), an input DID received from the processor is provided as the first output DID.

In another aspect, when the input PID is one of the first set of PIDs and the first DID select has a third value (e.g., 10), a combination of the first DID and an input DID received from the processor is provided as the first output DID.

In another aspect, the MDAC can further comprise a plurality of MDAC instances, wherein each MDAC instance comprises: one or more registers corresponding to a corresponding master coupled to the MDAC, and corresponding comparison circuitry configured to generate a corresponding output DID using the one or more registers in response to a corresponding input PID. The one or more registers of a first MDAC instance of the plurality of MDAC instances correspond to the first and second registers.

In further selected embodiments, a resource domain controller can comprise a master domain assignment controller (MDAC) (104) having a plurality of MDAC instances. Each MDAC instance can correspond to a corresponding master (102) coupled to the MDAC and a first MDAC instance of the plurality of MDAC instances corresponding to a first master can include: a plurality of registers (e.g., 202), wherein each register is configured to store a group identifier (e.g., PID, PIDM, and PE) which identifies a set of PIDs, and comparison circuitry configured to generate a first output DID using a hit register of the plurality of registers whose group identifier results in a hit of a first input PID received from the first master. The first input PID is one of the set of PIDs identified by the group identifier of the hit register. A switch fabric (106) can be coupled to receive the first output DID from the MDAC and coupled to a plurality of slaves, wherein the switch fabric is configured to provide communication between the masters and the slaves.

In another aspect, the first master provides the first input PID and an input DID to the MDAC, and an address and address attributes to the switch fabric, and the MDAC provides the first output DID to the switch fabric.

In another aspect, each group identifier of the first MDAC instance can include a PID and a PID mask, wherein the comparison circuitry determines which register of the plurality of registers results in a hit using the PIDs and PID masks.

In another aspect, each group identifier of the first MDAC instance can include a PID enable indicator, wherein the comparison circuitry determines which register of the plurality of registers results in a hit using the PIDs, the PID masks, and the PID enable indicators. If the PID enable indicator stored in the hit register has a first value, the PID stored in the hit register masked by the PID mask stored in the hit register matches the first input PID masked by the PID mask stored in the hit register, and if the PID enable indicator stored in the hit register has a second value, the PID stored in the hit register masked by the PID mask stored in the hit register does not match the first input PID masked by the PID mask stored in the hit register.

In another aspect, each register of the plurality of registers of the first MDAC instance is configured to store a DID and a DID select, wherein the first output DID is generated using the DID select stored in the hit register and at least one of the DID stored in the hit register and an input DID received from the processor.

In still further selected embodiments, in a master domain assignment controller (MDAC) having a plurality of registers, wherein each register is configured to store a group identifier which identifies a set of process identifiers (PIDs), a method comprises: receiving an input PID, and determining if a hit occurs with a register of the plurality of registers using the group identifier of each register. When a hit is determined of a hit register of the plurality of registers which indicates that the input PID is one of the set of PIDs identified by the hit register, an output DID is generated using the hit register.

In another aspect, the group identifier of each register can include a corresponding PID and PID mask, wherein the determining if the hit occurs with the register of the plurality of registers using the group identifier of each register is performed by using the PID and PID mask of each register.

In another aspect, the group identifier of each register can include a corresponding PID enable indicator, wherein the determining if the hit occurs with the register of the plurality of registers further comprises: when the corresponding PID enable indicator has a first value and the corresponding PID masked by the corresponding PID mask matches the input PID masked by the corresponding PID mask, a hit is determined; and when the corresponding PID enable indicator has a second value and the corresponding PID masked by the corresponding PID mask does not match the input PID masked by the corresponding PID mask, a hit is determined.

In another aspect, each register of the plurality of registers can be configured to store a corresponding DID and a corresponding DID select, the method can further comprise receiving an input DID, wherein the generating the output DID using the hit register can comprise: when the corresponding DID select of the hit register has a first value, the corresponding DID of the hit register can be provided as the output DID; and when the corresponding DID select of the hit register has a second value, the input DID can be provided as the output DID.

In another aspect, each register of the plurality of registers can be configured to store a corresponding DID, the method can further comprise: when a hit is determined of multiple hit registers of the plurality of registers in which each register of the multiple hit registers indicates that the input PID is one of the set of PIDs identified by the register of the multiple hit registers, generating an output DID using the corresponding DID of each of the multiple hit registers.

The term “software” or “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between logic blocks are merely illustrative and that alternative embodiments may merge logic blocks or circuit elements or impose an alternate decomposition of functionality upon various logic blocks or circuit elements. Those skilled in the art will also recognize the specific use of the process identifier as used herein can be replaced with any other processor-controlled programmable identifier.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

In one embodiment, system 100 is a computer system such as a server or personal computer system. Other embodiments may include different types of computer systems. Computer systems are information handling systems which can be designed to give independent computing power to one or more users. Computer systems may be found in many forms including but not limited to mainframes, minicomputers, servers, workstations, personal computers, notepads, personal digital assistants, electronic games, automotive and other embedded systems, cell phones and various other wireless devices. A typical computer system includes at least one processing unit, associated memory and a number of input/output (I/O) interfaces.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A master domain assignment controller (MDAC) comprising:
a first plurality of registers corresponding to a first processor, the first plurality of registers comprising a first register corresponding to a first set of process identifiers (PIDs) and a second register corresponding to a second set of PIDs; and
comparison circuitry coupled to receive an input process identifier (PID) from the first processor and configured to determine if the input PID is one of the first set or the second set of PIDs, wherein:
when the input PID is one of the first set of PIDs, a first output domain identifier (DID) is generated, and
when the input PID is one of the second set of PIDs, a second output DID different from the first output DID is generated.

2. The MDAC of claim 1, wherein the first register is configured to store a first group identifier which identifies the first set of PIDs and the second register is configured to store a second group identifier which identifies the second set of PIDs, wherein the comparison circuitry is configured to use the first group identifier to determine if the input PID is one of the first set of PIDs and the second group identifier to determine if the input PID is one of the second set of PIDs.

3. The MDAC of claim 2, wherein the first group identifier includes a first PID and a first PID mask, and the second group identifier includes a second PID and a second PID mask, wherein the comparison circuitry is configured to use the first PID masked by the first PID mask to determine if the input PID is one of the first set of PIDs and the second PID masked by the second PID mask to determine if the input PID is one of the second set of PIDs.

4. The MDAC of claim 3, wherein the first group identifier includes a first PID enable indicator, wherein the comparison circuitry is configured to:
when the first PID enable indicator has a first value, the input PID is one of the first set of PIDs if the first PID masked by the first PID mask matches the input PID masked by the first PID mask, and
when the first PID enable indicator has a second value, the input PID is one of the first set of PIDs if the first PID masked by the first PID mask does not match the input PID masked by the first PID mask.

5. The MDAC of claim 4, wherein the second group identifier is configured to store a second PID enable indicator, wherein the comparison circuitry is configured to:
when the second PID enable indicator has the first value, the input PID is one of the second set of PIDs if the second PID masked by the second PID mask matches the input PID masked by the second PID mask, and
when the second PID enable indicator has the second value, the input PID is one of the second set of PIDs if the second PID masked by the second PID mask does not match the input PID masked by the second PID mask.

6. The MDAC of claim 2, wherein the first register is configured to store a first DID and the second register is configured to store a second DID, wherein:
when the input PID is one of the first set of PIDs, the first output DID is generated using the first DID, and
when the input PID is one of the second set of PIDs, the second output DID is generated using the second DID.

7. The MDAC of claim 2, wherein the first register is configured to store a first DID and a first DID select and the second register is configured to store a second DID and a second DID select, wherein:
when the input PID is one of the first set of PIDs, the first output DID is generated using the first DID select and at least one of the first DID and an input DID received from the processor, and
when the input PID is one of the second set of PIDs, the second output DID is generated using the second DID select and at least one of the second DID and the input DID.

8. The MDAC of claim 7, wherein:
when the input PID is one of the first set of PIDs and the first DID select has a first value, the first DID is provided as the first output domain identifier, and
when the input PID is one of the first set of PIDs and the first DID select has a second value, an input DID received from the processor is provided as the first output DID.

9. The MDAC of claim 8, wherein when the input PID is one of the first set of PIDs and the first DID select has a third value, a combination of the first DID and an input DID received from the processor is provided as the first output DID.

10. The MDAC of claim 1, further comprising:
a plurality of MDAC instances, wherein each MDAC instance comprises:
one or more registers corresponding to a corresponding master coupled to the MDAC, and
corresponding comparison circuitry configured to generate a corresponding output DID using the one or more registers in response to a corresponding input PID,
wherein the one or more registers of a first MDAC instance of the plurality of MDAC instances correspond to the first and second registers.

11. A resource domain controller comprising:
a master domain assignment controller (MDAC) (104) having a plurality of MDAC instances, wherein each MDAC instance corresponds to a corresponding master (102) coupled to the MDAC and a first MDAC instance of the plurality of MDAC instances corresponding to a first master includes:
a plurality of registers (e.g. 202), wherein each register is configured to store a group identifier (e.g. PID, PIDM, and PE) which identifies a set of PIDs, and
comparison circuitry configured to generate a first output DID using a hit register of the plurality of registers whose group identifier results in a hit of a first input PID received from the first master, wherein the first input PID is one of the set of PIDs identified by the group identifier of the hit register; and
a switch fabric (106) coupled to receive the first output DID from the MDAC and coupled to a plurality of slaves, wherein the switch fabric is configured to provide communication between the masters and the slaves.

12. The resource domain controller of claim 11, wherein the first master provides the first input PID and an input DID to the MDAC, and an address and address attributes to the switch fabric, and the MDAC provides the first output DID to the switch fabric.

13. The resource domain controller of claim 11, wherein each group identifier of the first MDAC instance includes a PID and a PID mask, wherein the comparison circuitry determines which register of the plurality of registers results in a hit using the PIDs and PID masks.

14. The resource domain controller of claim 13, wherein each group identifier of the first MDAC instance includes a PID enable indicator, wherein the comparison circuitry determines which register of the plurality of registers results in a hit using the PIDs, the PID masks, and the PID enable indicators, wherein:
if the PID enable indicator stored in the hit register has a first value, the PID stored in the hit register masked by the PID mask stored in the hit register matches the first input PID masked by the PID mask stored in the hit register, and
if the PID enable indicator stored in the hit register has a second value, the PID stored in the hit register masked by the PID mask stored in the hit register does not match the first input PID masked by the PID mask stored in the hit register.

15. The resource domain controller of claim 11, each register of the plurality of registers of the first MDAC instance is configured to store a DID and a DID select, wherein the first output DID is generated using the DID select stored in the hit register and at least one of the DID stored in the hit register and an input DID received from the processor.

16. In a master domain assignment controller (MDAC) having a plurality of registers, wherein each register is configured to store a group identifier which identifies a set of process identifiers (PIDs), a method comprises:
receiving an input PID;
determining if a hit occurs with a register of the plurality of registers using the group identifier of each register; and
when a hit is determined of a hit register of the plurality of registers which indicates that the input PID is one of the set of PIDs identified by the hit register, generating an output DID using the hit register.

17. The method of claim 16, wherein the group identifier of each register includes a corresponding PID and PID mask, wherein the determining if the hit occurs with the register of the plurality of registers using the group identifier of each register is performed by using the PID and PID mask of each register.

18. The method of claim 17, wherein the group identifier of each register includes a corresponding PID enable indicator, wherein the determining if the hit occurs with the register of the plurality of registers further comprises:
when the corresponding PID enable indicator has a first value and the corresponding PID masked by the corresponding PID mask matches the input PID masked by the corresponding PID mask, a hit is determined; and
when the corresponding PID enable indicator has a second value and the corresponding PID masked by the corresponding PID mask does not match the input PID masked by the corresponding PID mask, a hit is determined.

19. The method of claim 18, wherein each register of the plurality of registers is configured to store a corresponding DID and a corresponding DID select, the method further comprising:
receiving an input DID, wherein the generating the output DID using the hit register comprises:
when the corresponding DID select of the hit register has a first value, the corresponding DID of the hit register is provided as the output DID; and
when the corresponding DID select of the hit register has a second value, the input DID is provided as the output DID.

20. The method of claim 16, wherein each register of the plurality of registers is configured to store a corresponding DID, the method further comprising:
when a hit is determined of multiple hit registers of the plurality of registers in which each register of the multiple hit registers indicates that the input PID is one of the set of PIDs identified by the register of the multiple hit registers, generating an output DID using the corresponding DID of each of the multiple hit registers.
